(19) United States
(12) Patent Application Publication
(10) Pub. No.: US 2014/0272157 A1
(43) Pub. Date: Sep. 18, 2014

(54) METHODS OF DISPENSING A VULCANIZABLE MATERIAL

(71) Applicant: DOUGLAS W. SCULL, San Marcos, CA (US)

(72) Inventor: DOUGLAS W. SCULL, San Marcos, CA (US)

(21) Appl. No.: 13/834,254

(22) Filed: Mar. 15, 2013

(51) Int. Cl. B05D 1/02

(52) U.S. Cl. CPC B05D 1/02
USPC 427/387; 427/372.2; 239/8; 239/1

(57) ABSTRACT

Methods of dispensing a room-temperature one-part or two-part vulcanizable material are disclosed. First, a curing material is supplied in a cartridge and the cartridge is inserted into a dispenser. The material is sprayed from the cartridge by actuation of the dispenser such that the material begins curing upon exiting the cartridge. Another method coats an object by positioning the object for coating, supplying a curing material in a cartridge, and inserting the cartridge into the dispenser. The method concludes by spraying from the dispenser the curing material toward the object such that the material begins curing upon exiting the cartridge.

### TECHNICAL FIELD

Generally, the present invention is directed to a method of dispensing “one-part” or “two-part” vulcanizable material. Specifically, the present invention is related to methods of dispensing a “one-part” room temperature vulcanizing (RTV) material or “two-part” material that cures in the presence of a catalyst and which is to be dispensed or applied to a surface.

### BACKGROUND ART

High voltage insulators are typically constructed of a ceramic or ceramic-like material. These insulators are used in power transmission systems, substations and any other high voltage application. It is also known to use glass and polymer insulators, such as EPDM, in the aforementioned settings. The insulators and related products are known to accumulate dust and/or sand, and in coastal regions salt. This accumulation of contamination is problematic in many locales and environments. One example is in areas next to a fossil-fueled power plant that generates fly ash which accumulates on nearby insulators. When such contamination accumulates on surfaces of the insulator, in the presence of moisture, the contamination can become electrically conductive which in turn causes a breakdown of the insulator resulting in flashover of the high voltage insulator. This flashover leads to damage of the associated electrical equipment.

One solution to this problem is to coat the insulator surface by spraying on a one-part or two-part silicone rubber material. This solution can potentially eliminate electrical flashover failures by negating the effects of the contamination. Typically, the silicone rubber coatings are almost always applied after manufacture of the insulator and after installation of the insulator in the field. The one-part material begins curing immediately upon exposure to moisture. It is also known to use “two-part” silicone materials to coat insulators for the reasons above and to coat objects to minimize or prevent their corrosion. The two-part materials require a base material and a catalyst to initiate curing. As such, the two-part materials must be mixed just prior to application. The two-part material begins curing immediately upon mixing of the two materials.

Applying either one-part or two-part coating materials to the insulator is typically done with standard paint dispensing equipment consisting of spray guns, pressure pots, a compressor for the supply of pressurized air, fluid pumps and lengths of hose through which the coating flows. Using paint-type dispensing equipment requires that the one-part material be transferred to a pot where it is exposed to moisture and begins curing. The two-part material must be mixed, which may or may not take place in a pot. As soon as the two-part materials begin to mix, the curing process starts. Once the mixing and transfer, if required, is complete, the pot is connected via hoses to the appropriate pumps and dispensing gun, and the dispensing may begin. Exemplary dispensing equipment is manufactured and sold by Binks and Devilbiss.

This standard approach is known to be problematic. Typically, the insulator manufacturer is not interested or familiar with the equipment and methods required to applying the coating. There are many reasons but the two biggest are (1) it increases the manufacturing cost of the insulator potentially reducing profit margins and competitiveness in the marketplace and (2) silicones tend to be very “contaminating” in a manufacturing environment. As such, glass or ceramic insulator manufacturers do not want cured or uncured silicone rubber material in their factory. As a result, the insulator manufacturer often refers their customer to the coating material manufacturer if the customer has an interest in coating new insulators.

The silicone coating material that is used is costly and clean-up of dispensing equipment is difficult, requiring the use of solvents that are considered hazardous and depending on the region of the world can be difficult to obtain. Therefore, the clean-up process is expensive and environmentally problematic. Additionally, significant training is required in the use of the dispensing equipment and in the proper methods required to uniformly apply the silicone coating material. Finally, utilizing the existing methods and dispensing equipment requires multiple passes of application of the silicone coating material to obtain the coating manufacturers recommended thickness of coating on the electrical insulator, generally between 15 and 20 mils. This requirement increases the time required to apply the manufacturers recommend thickness effectively increasing the cost to apply the silicone rubber coating. Additionally utilizing existing methods and dispensing equipment can result in waste of the silicone rubber coating due to inefficient application methods by untrained workers and inherent waste in the clean-up process. Accordingly, there is a need in the art for improved methods of dispensing a vulcanizable material.

### SUMMARY OF THE INVENTION

In light of the foregoing, it is a first aspect of the present invention to provide methods of dispensing a vulcanizable material.

It is another aspect of the present invention to provide a method of dispensing a material, comprising supplying a curing material in a cartridge, inserting the cartridge into a dispenser, and spraying the material from the cartridge by actuation of the dispenser such that the material begins curing upon exiting the cartridge.

It is yet another aspect of the invention to provide a method of coating an object comprising positioning an object for coating, supplying a curing material in a cartridge, inserting the cartridge into a dispenser, and spraying from the dispenser the curing material toward the object such that the material begins curing upon exiting the cartridge.

### BRIEF DESCRIPTION OF THE DRAWINGS

These and other features and advantages of the present invention will become better understood with regard to the following description, appended claims, and accompanying drawings wherein:

FIG. 1 is a schematic diagram presenting the components utilized in the methodology according to the concepts of the present invention.

### DETAILED DESCRIPTION

Referring now to the drawing, it can be seen that methods of dispensing a vulcanizable material are designated generally by the numeral 10. Initially, a container 12, which can be of any size ranging from 1 gallon to 50 gallons or more is provided which carries a material designated generally by the numeral 13. In the present embodiment, the material is a room-temperature vulcanizable material which is a one-part material that cures in the presence of moisture when applied, typically within an ambient temperature ranging between 32° F. to 150° F. (0° C.-65.6° C.). Skilled artisans will appreciate that curing of the material 13 is a function of moisture not necessarily temperature. The temperature range noted is a recommended range to apply the material. The material 13 may have a viscosity of 1000 to 10,000 centipoise. In some embodiments, the material may have a viscosity in the range of 5000 to 8000 centipoise. In other embodiments, the material may have a viscosity in the range of 1200 to 1500 centipoise.

In an alternative embodiment, a two-part material may be used in the dispensing method 10. In this embodiment, a container 14A provides a base material 15A and a container 14B provides a catalyst material 15B. The mixing ratios of the base material 15A and catalyst 15B depend upon their respective properties. Exemplary two-part materials cure independently of humidity/moisture and have a pot life of about one hour at 23° C. after mixing. In other words, the mixed two-part material must be dispensed prior to lapsing of the pot life.

Next, in a controlled factory environment, the material 13 is transferred from the container 12 into a cartridge designated generally by the numeral 16. As shown, the cartridge 16 is a single cylinder configuration similar to a caulk tube. In the present embodiment, the cartridge 16 provides a cylindrical body 17 which has a plunger 18 that is moveable within the cylindrical body and a dispense end 20 which includes a tip 22. As will be appreciated by the skilled artisan, the material is dispensed by exerting a pressure at the plunger 18 so that the enclosed material exits through the tip 22. An internal sealing mechanism may be provided within the tip 22. A removable plastic cap 23 is secured on to the tip 22 to prevent air and moisture from entering the barrel 17 after the sealing mechanism is broken.

In the alternative embodiment, the materials 15A and 15B may be transferred into separate barrels of a dual-barrel cartridge 24. In such a construction, the cartridge includes a barrel 26A and a barrel 26B positioned adjacent to one another and in some embodiments may be secured to one another. The base material 15A is received in barrel 26A and the catalyst material 15B is received in barrel 26B. The amount of material placed in each barrel is dependent upon the mixing ratio needed to initiate the curing process when the materials are eventually mixed. For all embodiments and as used herein, a cartridge is any appropriately sized container for fluid or liquid, such as the disclosed materials, made for ready insertion into some device or mechanism as will be described. In another embodiment, it will be appreciated that the material 13 could be placed in both barrels of the dual-barrel cartridge 24. Each barrel 26 has a moveable plunger 28 at one end. The opposite ends of each barrel 26 has a dispense end 29 that terminates at a single tip 30.

The dispensing end 29 is provided with an internal sealing mechanism that comprises a plastic cap with two small portions which extend into each barrel (one associated with each barrel). A small disc, which may be made of rubber, is placed over the plastic cap so that the plastic cap and disc can be held in place by a replaceable and reusable screw cap 31 that is secured to the tip 30. Other internal sealing mechanisms could be used in conjunction with the screw cap 31.

When cap 23 or 31 is removed and the internal sealing mechanisms are broken, if provided, and a pressure or force is applied to the plunger 18 or 28A/28B and the material 13 in the cylindrical body 17 or materials 15A and 15B in barrels 26A/26B flow out through the respective tip 22 or 30. After the desired amount of material is dispensed, the caps can be refastened to the tips to prevent further dispensing and to prevent the undispensed material from prematurely curing. After sealing or resealing, the cartridges 16, 24 may then be shipped and/or stored until needed. Indeed, the plunger 18 and the cap 23 prevent the material 13 from being exposed to ambient conditions and moisture and thus prematurely curing. Likewise, the plungers 28A/28B and the cap 31 prevent the materials 15A and 15B from mixing and thus prematurely curing.

When the respective material is ready to be dispensed from the cartridge 16 or 24 on to a surface, the cartridge 16 or 24 is positioned into a pressurized air-operated spray gun designated generally by the number 34. The spray gun 34 provides for a cartridge holder 36 appropriately sized to receive either the single cylinder cartridge 16 or the dual-barrel cartridge 24. A pressurized air supply 38 is associated with the spray gun and application of the pressurized air, controlled by a hand-operated or automated trigger valve, moves a cartridge ram 40 or other mechanism carried by the spray gun so as to engage and apply a force to the plunger 18/28 of the respective cartridge. The cartridge ram 40 may also be moved by other kinds of forces such as electrical, electro-mechanical, hydraulic and so on.

The spray gun 34 provides a spray tip/mixer 42 that is attached to the tip 22/30 of each cartridge. Just prior to attaching the spray tip/mixer to the cartridge, the technician removes the cap 23/31 and the internal plug or sealing mechanism to enable the material to flow out of the tip 22/30. The mixer 42 includes a tube 44 which has an inlet 46 at one end that is connected to the tip 22/30 and an outlet 48 at an opposite end. Maintained internally within the tube 44 are a plurality of ribs 50 which provide for helical mixing or mixing of any kind as the material traverses from the inlet 46 to the outlet 48. Some embodiments may provide a mixer tube without internal ribs.

A spray tip 54 is coupled to the outlet 48 and provides a nozzle end 56 from where the material exits the spray tip/mixer 42 in the form of a spray. To assist in dispensing material from the spray/tip mixer 42, the nozzle end 56 includes an air supply port 58. The air supply port 58 receives pressurized air from the air supply 38 which may also be used to operate the cartridge ram 40. The pressurized air, which may be regulated by a valve, assists in propelling and atomizing the material from the tip 54 onto the object which is being sprayed. As used herein, spray means a fluid or liquid material that is broken up into minute droplets or particles and blown, propelled or ejected from the spray tip into the surrounding ambient air or environment. An exemplary spray/tip mixer is disclosed in U.S. Pat. No. 6,601,782 which is hereby incorporated by reference. The air entering the port 58 mixes with the material 13 or materials 15A/15B and atomizes the material. In other words, the air pressure causes the material to exit the nozzle end in droplet form, in fine particles so as to enhance coverage of the material on the object to be covered. Adjustment of the pressure of the air supplied to the port can vary the droplet or particle size. Adjustment of the pressure applied by the air supply 38 to the cartridge ram 40 and subsequently the plunger 18 or 28A/28B also determines the rate at which the material 13 or 15A/15B exits the nozzle 56 and the size of the material droplets.

It is believed that by spraying or dispensing the material 13 from the cartridge 16, which is a substantially sealed container, no air or moisture comes in contact with the material until the time the material exits the cartridge 16 and enters the nozzle 56 from the mixer 42. As a result, the amount of moisture and/or air exposed to the material is limited and the curing of the one-part material only begins as it exits the tube 44 and is exposed to air in the nozzle 56. This enhances the flowability of the material 13 after leaving the nozzle and improves the coverage of the material on the object to be coated. It is also believed that as the material 13 passes through the tube 44 and in particular, the internal ribs, the material is sheared and mixed and assists in the uniformity of the material exiting the nozzle end 56. When dispensing two-part materials from the sealed cartridge 24, the cap 31 is removed and the internal sealing, if provided, is removed or broken. In the same manner as the other embodiment, a force is applied to the plungers 28A/28B and the material 15A/15B exits the tip 30 and begins mixing and curing upon entering the mixer 42. In other words, the curing material (the base material 15A and the catalyst material 15B) begins curing upon exiting the cartridge and entering the mixer.

Upon exiting the spray gun 34 the material 13 or 15A/15B is applied to an electrical insulator 60 or other object and provides a coating thereon designated by the number 62. This delayed curing and mixing of the material provides a uniform coating on the object or electrical insulator and a thickness that is unattainable using standard type dispensing sprayers. In other words, in contrast to prior art dispensing systems in which the material begins curing upon transfer from shipping containers (one-part material) or mixing (two-part material in a pot) and requires the material to traverse from the pot through hoses and a dispensing gun, the present system effectively dispenses the material virtually immediately after the curing process begins. Indeed, in evaluating the cartridges for dispensing the room-temperature vulcanizable material, the consistency and thickness of the material dispensed was unexpected inasmuch as the properties of the material were already thought to be adequately dispensed utilizing prior art equipment. However, it has been found by utilizing the combination of curing immediately after moisture exposure or mixing, the internal helical mixing of the tube 44 and/or the use of pressurized air supply port 58 that a uniform coating of desired thickness can be obtained. Moreover, it has been found that the desired coating thickness can be obtained in a single pass instead of multiple passes as required by the dispensing equipment currently used.

It is believed that dispensing one-part room-temperature vulcanizable silicone material from an unsealed container and permitting entrained entrapped air and associated moisture results in premature curing of the material. It is believed that the primary reason for multiple passes in prior art systems is that the coating must be diluted to accommodate the traditional spray system being used which results in less solid material being applied to the surface in a single pass. Likewise, it is also believed that since two-part room-temperature vulcanizable silicone material begins curing immediately upon mixing, the delay in dispensing the material from the time it begins curing using traditional spray systems also results in less solid material being applied to a surface in a single pass. Therefore, with either one-part or two-part material, in prior art systems it takes multiple passes to build up enough material to get to the required thickness. If the installer tries to put too much material on at one, time the coating runs and sags just like an excessive application of paint. As a result, an unacceptable surface is obtained. In contrast, the disclosed method 10 utilizing the cartridge system can spray the material as manufactured without the need to further dilute. As such, multiple dispensing passes are not required to obtain a desired amount of coverage thickness.

In an alternative embodiment, it will be appreciated that the insulator 60 or other surface to receive the coating may be mounted on a moveable platform 64. The platform 64 is moveable in any number of degrees of motion so as to allow for the insulator 60 to be moved during the spraying process. In this alternative embodiment it will also be appreciated that the spray gun 34 may be mounted on a moveable platform 66 that allows for the spray gun or equivalent dispensing device to be moved in any number of degrees of motion. Both the platforms 64 and 66 and the pressurized air supply 38 are connected to a control system 70 which allows for control of the motion of both platforms and also controls the rate of dispensing material from the spray gun mounted on the platform 66. This may include the control system controlling the amount and timing of pressurized air to the cartridge ram 40 and/or the air supply port 58.

The control system 70 provides the necessary hardware and software to control the platforms, the spray gun/dispensing device, associated valves, the air supply and any other environmental controls to obtain an optimum coating of the object. As a result, large quantities of insulators can be uniformly coated with a desired thickness in an efficient manner in contrast to a hand-held manually applied operation of the spray gun. The control system 70 can control the various movements of the platforms 64 and 66 to optimize use of material and application thereof.

Based on the foregoing, the advantages of the present invention are readily apparent. By utilizing cartridge assemblies, the end-user does not need to utilize elaborate paint dispensing equipment that requires cleanup and potentially wasted material. As noted, materials left over after using standard type dispensing equipment must be thrown away. In the disclosed methods, if the full amount of material is not used, the cartridge can be removed from the dispensing system and capped for preserving the qualities of the material for later use. Utilization of the present method is also advantageous in that a desired thickness of coating can be obtained in a single pass as opposed to multiple passes required by use of standard type dispensing equipment. This allows for less skilled personnel to dispense the material in comparison to currently used dispensing equipment. Skilled artisans will also appreciate that the methods disclosed herein allow for simplified application of silicone rubber, or any one-part or two-part curing material with similar properties to any surface that needs protection from a corrosive environment. And the RTV material, or any similar moisture-induced or catalyst curing material, can be applied to products not generally considered an insulator, but any piece of equipment which would be found in an electrical substation or any other facility.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A method of dispensing a material, comprising:
supplying a curing material in a cartridge;
inserting said cartridge into a dispenser; and
spraying said material from said cartridge by actuation of said dispenser such that said material begins curing upon exiting said cartridge.

2. The method according to claim 1, further comprising:
providing said cartridge with at least one moveable plunger; and
applying a force to said moveable plunger.

3. The method according to claim 1, further comprising:
dispensing said material through a tube coupled to said cartridge.

4. The method according to claim 3, further comprising:
coupling a nozzle to an outlet of said tube;
providing said nozzle with a port to receive pressurized air; and
supplying pressurized air into said port to propel said material from said tube.

5. The method according to claim 4, further comprising:
providing said tube with internal mixing ribs; and
selecting a one-part room-temperature vulcanizable silicone for said curing material that begins curing upon exiting said tube.

6. The method according to claim 4, further comprising:
providing said tube with internal mixing ribs; and
selecting a two-part room-temperature vulcanizable silicone for said curing material that begins curing upon mixing by said internal mixing ribs.

7. The method according to claim 1, further comprising:
selecting a one-part room-temperature vulcanizable silicone for said curing material.

8. The method according to claim 1, further comprising:
selecting a two-part room-temperature vulcanizable silicone for said curing material.

9. A method of coating an object comprising:
positioning an object for coating;
supplying a curing material in a cartridge;
inserting said cartridge into a dispenser; and
spraying from said dispenser said curing material toward the object such that said material begins curing upon exiting said cartridge.

10. The method according to claim 9 further comprising:
spraying said material from a hand-held dispensing device.

11. The method according to claim 10, further comprising:
dispensing said material through a tube coupled to said cartridge.

12. The method according to claim 11, further comprising:
coupling a nozzle to an outlet of said tube;
providing said nozzle with a port to receive pressurized air; and
supplying pressurized air into said port to propel said material from said tube.

13. The method according to claim 12, further comprising:
selecting a one-part room-temperature vulcanizable silicone for said curing material that begins curing upon exiting said tube.

14. The method according to claim 12, further comprising:
providing said tube with internal mixing ribs; and
selecting a two-part room-temperature vulcanizable silicone for said curing material that begins curing upon mixing by said internal mixing ribs.

15. The method according to claim 9 further comprising:
spraying said material from an automated dispensing device.

16. The method according to claim 15, further comprising:
positioning the object on a movable platform; and
moving at least one of said movable platform and said automated dispensing device while spraying so as to coat the object with said material.

17. The method according to claim 16, further comprising:
dispensing said material through a tube coupled to said cartridge.

18. The method according to claim 17, further comprising:
coupling a nozzle to an outlet of said tube;
providing said nozzle with a port to receive pressurized air; and
supplying pressurized air into said port to propel said material from said tube.

19. The method according to claim 18, further comprising:
selecting a one-part room-temperature vulcanizable silicone for said curing material that begins curing upon exiting said tube.

20. the method according to claim 18, further comprising:
providing said tube with internal mixing ribs; and
selecting a two-part room-temperature vulcanizable silicone for said curing material that begins curing upon mixing by said internal mixing ribs.

21. The method according to claim 9, further comprising:
selecting a one-part room-temperature vulcanizable silicone for said curing material.

22. The method according to claim 9, further comprising:
selecting a two-part room-temperature vulcanizable silicone for said curing material.
